(19) United States
(12) Patent Application Publication
(10) Pub. No.: US 2010/0293465 A1
(43) Pub. Date: Nov. 18, 2010

(54) Teleprompter System, Method, And Device

(76) Inventors: Paul E. Kleinschmidt, Vass, NC (US); Joshua Hinman, Los Angeles, CA (US); Scott C. Helf, Corona, CA (US); Sean M. Siler, Southern Pines, NC (US); Simon Chelebyan, Reseda, CA (US)

Correspondence Address: MCKENNA LONG & ALDRIDGE LLP, 1900 K STREET, NW, WASHINGTON, DC, 20006, US

(21) Appl. No.: 12/780,844

(22) Filed: May 14, 2010

Related U.S. Application Data
(60) Provisional application No. 61/178,383, filed on May 14, 2009.

(51) Int. Cl. G06F 3/048; G06F 17/30

(52) U.S. Cl. 715/719; 715/774; 707/740; 707/E17.046; 707/E17.002

(57) ABSTRACT

A system used for teleprompter service includes a server including a processor operationally coupled to a database, a memory, and a communications interface. The memory stores instructions that cause the server to receive video captured by a web camera and audio captured by a microphone. The video and audio are the recordings of a user's oral presentation. The server contemporaneously transmits, via the communication interface, data representative of text stored in the database, wherein the text is scrolled across a video monitor at a speed selected in real time by a user.

### TECHNICAL FIELD

This application relates to a webpage, such as that used to interface with the Internet, that offers a teleprompter service. More specifically, the application relates to a system, method, and device and that provides a user with an ability to record video, audio, and text into a central searchable database via a communications network, such as the Internet. The system, method, and device and may make use of an imaging device, such as a video camera, an audio pick-up device, such as a microphone, a monitor for viewing of the webpage, and an input device, such as a keyboard/mouse, for entering data or manipulating features of the webpage. According to the method, and as implemented in the device and system, the text from the database can be scrolled across the webpage as the user reads the text and as the user is recorded for video image and sound.

### BACKGROUND

Teleprompters are devices that allow a user to read a script while looking into a lens of a motion picture or video camera. A skilled user of a teleprompter can make the viewing audience believe that the user's words are being spoken extemporaneously, despite the fact that the words are being read. A teleprompter can be a device that includes a partially reflective/partially transmissive mirror placed at a 45-degree angle in front of a camera lens. The lens captures the image seen directly in front of the camera, through the mirror. At the same time, the image from a scrolling roll of paper, or a video screen having text scrolling thereon, is positioned with respect to the camera, at an angle that is orthogonal to the line of sight of the camera lens. The image of the scrolling paper or video screen is reflected by the mirror toward the user, along the line of sight of the camera lens. In such a system, the characters on the scrolling paper or on the video screen must be flipped and inverted to compensate for their being read as a mirror image.

A teleprompter may also be configured as a scrolling roll of paper, or a video screen having text scrolling thereon, that is positioned adjacent to the camera lens, either above, below, or to the left or right of the lens. This type of configuration avoids having to print text in a form that is a mirror image of normally written text. In these positions, however, the user's eyes will not be able to stare directly into the camera lens while the user is reading text from the teleprompter.

A user's recitation of a monolog read from a teleprompter may or may not amount to a verbatim recitation of the text presented to the user. Some users use the text of a teleprompter only to remind them of the topics they are presenting. These users may not have teleprompter scripts that are complete writings; rather they may simply contain bullet points. Other users may rigidly recite the text presented to them on the teleprompter. Between the two extremes are the users whose presentations are partially read and partially extemporaneous. Because of the great variation of style in use of the teleprompter, teleprompter scripts are not reliable transcripts of presentations. Methods of making transcripts are known. Additionally, because users may not want to allow others to know the secrets of how they use a teleprompter, teleprompter scripts are not usually maintained and cataloged for future reference.

What is needed is a teleprompter that is easily implemented, whose scripts can be reliably used as a transcript of a presentation, and whose scripts are cataloged and indexed for searching purposes.

### SUMMARY

In one embodiment, a system for use as a teleprompter may include a service provider's server, having a processor that is operationally coupled to a database, a memory, and a communications interface. The memory can store computer readable instructions that, when executed by the processor, cause the server to receive data representative of a video image captured by an image capture device and data representative of audible speech made contemporaneously with the video image; and transmit data representative of text stored in the database, wherein the text is scrolled across a video monitor at a speed selected in real time by a user. The video and audio are may be the recording of a user's oral presentation. The text may be a prewritten script, which the user may read while being recorded for video and sound. The user can, subsequent to being recorded, go back to the script and edit it so that it matches the presentation as-given.

In another embodiment, a method according to the invention may include receiving, at a user device, data representative of text stored in a database, scrolling the text within a first predefined area of a webpage, the webpage displayed on a monitor of the user device, displaying, within a second predefined area of the webpage, a real time video image captured by an image capture device of the user device, wherein the real time video image is displayed during the scrolling of the text.

In still another embodiment of the invention, a device, for use as a teleprompter, may include a processor operationally coupled to a memory, a microphone, an image capture device, and a monitor, wherein the memory stores instructions that, when executed by the processor, cause the processor to receive and store data in the memory, the data representative of a video image captured by the image capture device and audible speech made contemporaneously with the video image and captured by the microphone, receive data representative of text stored in a database, scroll the text within a first predefined area of a webpage, the webpage displayed on the monitor, and display, within a second predefined area of the webpage, the video image captured by the image capture device, wherein the data representative of the video image and the data representative of audible speech are stored while text corresponding to the video image and audible speech is scrolled within the first predefined area.

An unexpected and advantageous effect of the use of the invention is that any user can search the system provider's server for words or phrases that were actually used and approved by the user that made the presentation. Advertisers of certain products could be enticed to advertise on the system based, for example, on the number of times their product appeared in the service provider's server. Accuracy between the spoken word and the stored text is excellent because there is no transcription error to deal with. There is no transcription error between the spoken text and the text stored on the server, because a third party is not used and not needed to transcribe the speech. Transcription errors, such as, for example, erroneously transcribing the words “ambient sea air” instead of the trademark “Ambian CR” would be eliminated. An advertiser or a user searching the claimed system for the word “Ambian” would presumably have a higher number of hits when compared to the same search of a system that used human or machine transcription. So long as the user reads the stored text, the stored text will match the user's spoken word. Even if the user departs from the written text, the system would still contain the text approved by the user, which is presumably free from errors and incorrect nomenclature. Moreover, the user can go back and edit the text to match the spoken words, if the user departed from the written word.

These and other advantages of the invention will be realized and attained by the system, method, and device pointed out in the written description and claims thereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

FIG. 1 is a block diagram of a system in accordance with an embodiment of the invention.

FIG. 2 is an illustration of a webpage at a first moment in time, in accordance with an embodiment of the invention.

FIG. 3 is an illustration of the webpage at a second moment in time, in accordance with an embodiment of the invention.

FIG. 4 is an illustration of the webpage at a third moment in time, in accordance with an embodiment of the invention.

FIG. 5 is an illustration of the webpage at a fourth moment in time, in accordance with an embodiment of the invention.

### DETAILED DESCRIPTION OF THE EMBODIMENTS

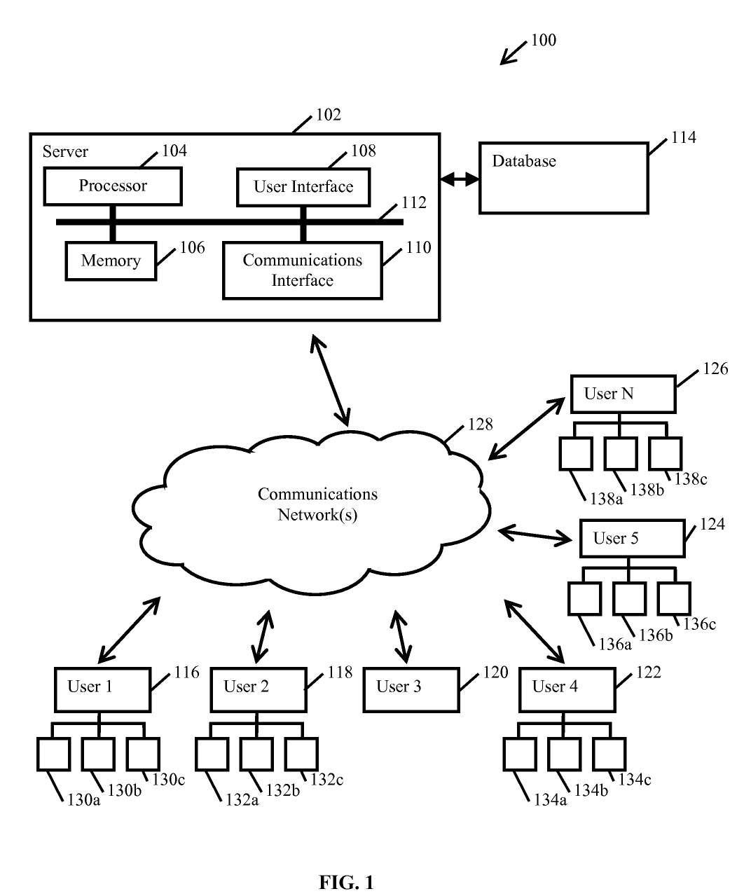

FIG. 1 is a block diagram of a system 100 in accordance with an embodiment of the invention. The system 100 includes a server 102, which includes a processor 104, a memory 106, a user interface 108, a communications interface 110, and a communications bus 112 that may have each of said items operationally coupled thereto. The server 102 may be operationally coupled to a database 114. Of course, the database 114 may reside in a memory, such as memory 106. Thus, the database 114 may be remote or local to the server.

The server 102 may be operationally coupled to one or more communication networks(s) 128, such as the Internet or the public switched telephone network (PSTN), via the communications interface 110. Communicating with the server 102 via the one or more communication network(s) 128 are one or more users (e.g., User 1, User 2, User 3, User 4, User 5, . . . , User N, where N is any positive integer). Communication may be facilitated by each user's operation/use of devices 116, 118, 120, 122, 124, 126. Similar to the server 102, each device 116, 118, 120, 122, 124, 126 may include a processor, a memory, a user interface, a communications interface, and a communications bus operationally coupled thereto. Examples of devices 116, 118, 120, 122, 124, 126 include computers, such as personal computers and servers. For purposes of illustration in FIG. 1, the user interfaces of devices 116, 118, 122, 124, and 126 are depicted as three blocks.

A first block (130a, 132a, 134a, 136a, 138a) may represent an image capture device, such as a video camera (also referred to herein as a “webcamera”). A second block (130b, 132b, 134b, 136b, 138b) may represent an audio pick-up device, such as a microphone. A third block (130c, 132c, 134c, 136c, 138c) may represent a monitor. User interfaces may also include a keyboard for entering data into the processor/memory and a mouse or other pointing device for manipulating fields and features of a graphical user interface, such as those found on a webpage.

Although depicted as being external to the device, one or more of the components of a user interface may be physically integrated within the device, as shown by device 120. An example of such an integrated device may include a tablet personal computer, which integrates a video camera, microphone, monitor, and keyboard into one portable structure. By way of example only, users may include physicians, physician assistants, dentists, lawyers, physical therapists, psychologists, chiropractors, nurse practitioners, midwives, and other licensed professionals, as well as common laypersons. The users may also include advertisers or researchers, for example.

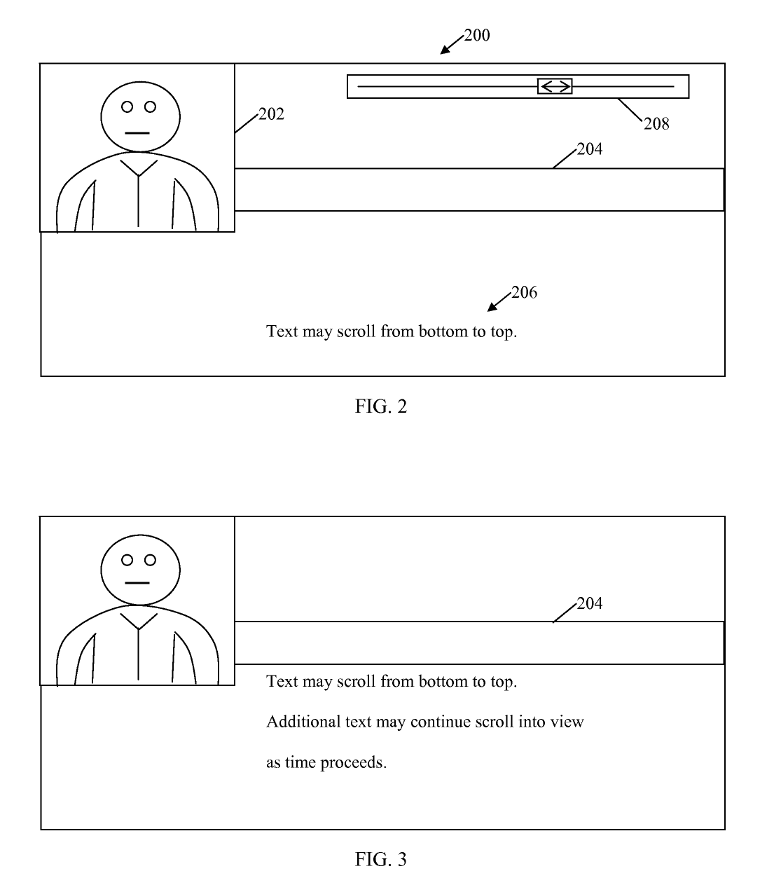

FIG. 2 is an illustration of a webpage at a first moment in time, in accordance with an embodiment of the invention. A user with a webcamera 130a, microphone 130b, and monitor 130c, might access the World Wide Web using a browser to display the webpage 200 on the user's monitor 130c. The webcamera 130a may capture the image of the user for display on the user's monitor 130c. The image may be in a corner of the webpage 200, in a predefined video box 202. The user, or any person with the permission of the user, might have previously stored a text file on a service provider's server 102 (FIG. 1). More specifically, the text file may be stored in a database 114 (FIG. 1) residing on a local or remote memory 106 (FIG. 1).

As shown in the sequence of figures (FIGS. 2-5), the representation of the text of the text file would be caused to scroll across the user's monitor, within a predefined area. In one embodiment, the text scrolls vertically within a text scrolling area, for example, a band extending from the bottom to the top of webpage 200.

Within the text scrolling area there may be a “cuing area” 204. The cuing area 204 may provide a visual reference, or place holder, for the user. In other words, if the user glances away from the monitor, he will be able to quickly isolate the desired text from the remainder of the text, as the desired text would generally be within or close to the cueing area 204. In one embodiment, the cueing area 104 is a transparent yellow band running horizontally across a portion of the webpage. Text passes through the band, but is not obscured by the band due to its transparency. Other ways to identify desired text from the remainder of the text, such as using a bold or italicized font, are within the scope of the invention.

The system may permit the text to be scrolled at a variable speed. The user may be able to adjust the scrolling speed. Various ways of implementing speed adjustment are within the scope of the invention. For example, in one embodiment, a virtual sliding control 208 may be caused to appear on, and disappear from, the webpage 200. The virtual sliding control 208 may be manipulated by a mouse or keyboard controls.

The user can practice reading the text while watching his image in the predefined video box 202 on the monitor 130c. During practice, the user can learn what pace of presentation works best for him. Once the user is satisfied with the text, the location of the text scrolling area, and the scroll speed, the user could capture his presentation by causing the system to record video from the webcamera 130c, audio from the microphone 130b, and scroll text across the screen of the monitor 130c within the webpage 200. Scroll speed may be adjusted during recording, just as it was during the user's practice.

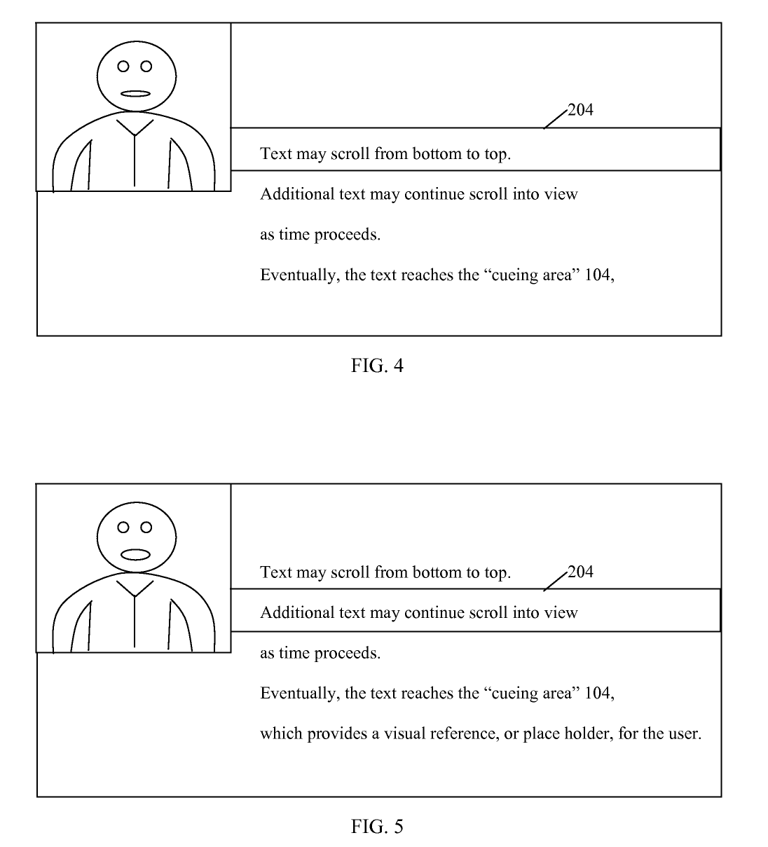

As shown in the sequence of figures, FIGS. 2-5, in one embodiment text may scroll from bottom toward the top of the webpage. FIG. 2. Additional text may continue scroll into view from the bottom of the scroll area as time proceeds. FIG. 3. Eventually, depending on the scrolling speed selected by the user, the text reaches the “cueing area” 204. FIG. 4. The cuing area 204 provides a visual reference, or placeholder, for the user. As time continues even further, text exits that cuing area 204 and proceeds upward, as additional text from below scrolls into the cueing area. FIG. 5.

At the conclusion of his presentation, the user could cause the system to stop recording and save the recorded video and audio data on the service provider's server 102. The text file was previously stored on the server 102. Any user with permission could access the system and search the text stored in the system's database 114. Once a user identifies appropriate text, he can watch the speaker give the presentation associated with that text.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A system, comprising:
a service provider server, comprising:
a processor;
a database operationally coupled to the processor;
a memory operationally coupled to the processor;
a communications interface operationally coupled to the processor, wherein the memory stores instructions that, when executed by the processor, cause the server to:
receive, via the communications interface:
data representative of a video image captured by an image capture device;
data representative of audible speech made contemporaneously with the video image; and
transmit, via the communication interface:
data representative of text stored in the database, wherein the text is scrolled across a video monitor at a speed selected in real time by a user.

2. The system of claim 1, wherein the text is cataloged and indexed for searching purposes.

3. The system of claim 1, further comprising the device of claim 10.

4. A method, comprising:
receiving, at a user device, data representative of text stored in a database;
scrolling the text within a first predefined area of a webpage, the webpage displayed on a monitor of the user device;
displaying, within a second predefined area of the webpage, a real time video image captured by an image capture device of the user device, wherein the real time video image is displayed during the scrolling of the text.

5. The method of claim 4, wherein the data is received from a server remote to the user device.

6. The method of claim 4, wherein the text is scrolled at a variable speed.

7. The method of claim 6, wherein the variable speed is selected in real time by a user of the device.

8. The method of claim 4, further comprising:
recording, on a memory of the user device, the video image captured by the image capture device; and
recording, on the memory of the user device, audible speech associated with the video image, the audible speech captured by a microphone of the user device and synchronized to the video image.

9. The method of claim 8, further comprising:
storing the recorded video image and synchronized audible speech associated with the text, in the database, wherein the text is cataloged and indexed for searching purposes.

10. A device, for use as a teleprompter, comprising:
a processor;
a memory operationally coupled to the processor;
a microphone operationally coupled to the processor;
an image capture device operationally coupled to the processor;
a monitor operationally coupled to the processor;
wherein the memory stores instructions that, when executed by the processor, cause the processor to:
receive and store data in the memory, the data representative of a video image captured by the image capture device;
receive and store data in the memory, the data representative of audible speech made contemporaneously with the video image and captured by the microphone;
receive data representative of text stored in a database;
scroll the text within a first predefined area of a webpage, the webpage displayed on the monitor;
display, within a second predefined area of the webpage, the video image captured by the image capture device, wherein the data representative of the video image and the data representative of audible speech are stored while text corresponding to the video image and audible speech is scrolled within the first predefined area.

11. The device of claim 10, wherein the data is received from a server remote from the device.

12. The device of claim 10, wherein the text is scrolled at a variable speed.

13. The device of claim 12, wherein the variable speed is selected in real time by a user of the device.

14. The device of claim 10, wherein the text stored in the database is cataloged and indexed for searching purposes.
